(19) United States
(12) Patent Application Publication
(10) Pub. No.: US 2008/0105770 A1
(43) Pub. Date: May 8, 2008

(54) Injection Valve and Method for Assembling the Injection Valve

(76) Inventors: Enio Biasci, Campo (IT); Mauro Grandi, Livorno (IT)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/926,800

(22) Filed: Oct. 29, 2007

(30) Foreign Application Priority Data
Nov. 2, 2006 (EP) 06022851

(51) Int. Cl. B05B 1/30; B21D 51/16; F02M 41/16

(52) U.S. Cl. 239/584; 239/96; 29/890.131

(57) ABSTRACT

An injection valve has an injector body with a recess and a valve body with a recess and a tip away from which a first axial section of the valve body is formed at an axial end area. The first axial section is arranged in the injector body recess having a slight clearance fit to a wall of the injector body recess. A needle body is partly and axially movable arranged in the injector body recess and protrudes into the valve body recess to prevent a fluid flow through the injection nozzle when closed and enables the fluid flow through the injection nozzle otherwise. A fitting body is formed and arranged between the first axial section of the valve body and the wall of the recess of the injector body such that the valve body and the fitting body are fixed to the injector body by a frictional connection.

### CROSS-REFERENCE TO RELATED APPLICATIONS

This application claims priority to European Patent Application Number 06022851 filed on Nov. 2, 2006, and which is incorporated herein by reference in its entirety.

### TECHNICAL FIELD

The invention relates to an injection valve for dosing fluid. The injection valve comprises an injector body. The injector body has a recess of the injector body. A valve body has a recess of the valve body and an injection nozzle at a tip of the valve body. A first axial section of the valve body is formed at an axial end area of the valve body facing away from the tip of the valve body. The first axial section of the valve body is arranged in the recess of the injector body.

### BACKGROUND

The injection valve may be used for dosing fluid. In particular, the injection valve may be used for dosing fuel into a combustion chamber of an internal combustion engine. If the injection valve is arranged at the internal combustion engine of a car, the dosing of fluid by the injection valve has to be very precise, in order to achieve emission restrictions and to realize a low fuel consumption while providing maximum power. Therefore, in general injection valves are calibrated before they are arranged in an internal combustion engine. The calibration may effect a force which acts on a needle of the injection valve and/or the calibration may effect a movability of the needle.

### SUMMARY

An injection valve and a method for assembling the injection valve may enable a precise dosing of fluid by the injection valve in an easy way. According to an embodiment, an injection valve for dosing fluid may comprise an injector body having a first recess, a valve body having a second recess and having an injection nozzle at a tip of the valve body, a first axial section of the valve body which is formed at an axial end area of the valve body facing away from the tip of the valve body and which is arranged in the first recess comprising a slight clearance fit to a wall of the first recess, a needle body which is partly and axially movable arranged in the first recess and which protrudes into the second recess in such a way that it prevents a fluid flow through the injection nozzle in a closed position and that it enables the fluid flow through the injection nozzle outside of the closed position, and a fitting body which is formed and arranged between the first axial section of the valve body and the wall of the first recess in such a way that the valve body and the fitting body are fixed to the injector body by a frictional connection.

According to a further embodiment, the first axial section of the valve body may comprise a circumferential groove which partly takes in the fitting body. According to a further embodiment, the fitting body may comprise a material which has a smaller Young's modulus of elasticity than the material of the valve body and/or of the injector body. According to a further embodiment, the fitting body may comprise a fitting ring which is formed in such a way that the frictional connection between the valve body and the injector body may be realized by a slight interference fit between the fitting ring and the wall of the first recess. According to a further embodiment, the valve body and the injector body may be fixed together by an overlap weld at the injector body. According to a further embodiment, the recess of the injector body may comprise a step of the first recess, the needle body may comprise an armature and a needle, the armature may be axially arranged between the step of the first recess and the first axial section of the valve body, and the needle may protrude into the second recess. According to a further embodiment, the injector body may comprise an injector housing and a valve body shell, the first recess may comprise a third recess of the valve body shell, and the first axial section of the valve body may be arranged in the third recess.

According to another embodiment, a method for assembling an injection valve, may comprise the steps of: partly arranging a needle body in a first recess formed in an injector body, arranging a first axial section of a valve body and a fitting body in the first recess with the fitting body being arranged between the first axial section of the valve body and a wall of the first recess and wherein the relative axial position of the valve body to the injector body is representative for an axial movability of the needle body in the first recess, welding the injector body to the valve body by heating the injector body from the outside of the injector body in radial direction.

According to a further embodiment, the method may further comprise the steps of partly arranging a fitting ring in a groove of the first axial section of the valve body and inserting the first axial section of the valve body with the fitting ring into the first recess.

### BRIEF DESCRIPTION OF THE DRAWINGS

The invention is explained in the following with the aid of schematic drawings.

These are as follows:

FIG. 1 an injection valve,

FIG. 2 a detailed view of the injection valve according to FIG. 1.

### DETAILED DESCRIPTION

According to an embodiment, an injector body has a recess of the injector body. A valve body of the injection valve has a recess of the valve body and an injection nozzle at a tip of the valve body. A first axial section of the valve body is formed at an axial end area of the valve body facing away from the tip of the valve body. The first axial section of the valve body is arranged in the recess of the injector body comprising a slight clearance fit to a wall of the recess of the injector body. A needle body is partly and axially movable arranged in the recess of the injector body. The needle body protrudes into the recess of the valve body in such a way that it prevents a fluid flow through the injection nozzle in a closed position of the needle body and that it enables the fluid flow through the injection nozzle outside of the closed position of the needle body. A fitting body is formed and arranged between the first axial section of the valve body and the wall of the recess of the injector body. The fitting body is arranged in such a way that the valve body and the fitting body are fixed to the injector body by a frictional connection.

The clearance fit of the first axial section of the valve body to the wall of the recess of the injector body enables an easy insertion of the first axial section of the valve body into the recess of the injector body. Further, the clearance fit provides a proper guidance of the valve body in the recess of the injector body. The fitting ring contributes to a proper provisional coupling of the valve body to the injector body. This contributes to an easy and precise assembling of the injection valve and, in particular, of the valve body to the injection valve. If the axial position of the valve body relative to the injector body is representative for a movability of the needle, the precise assembling of the valve body to the injector body contributes to a precise dosing of fluid by the injection valve in an easy way.

According to an embodiment, the first axial section of the valve body comprises a circumferential groove which partly takes in the fitting body. This contributes to a proper positioning of the fitting body.

According to a further embodiment, the fitting body comprises a material which has a smaller Young's modulus of elasticity than the material of the valve body and/or of the injector body. This contributes to an easy fixation of the valve body to the injector body by the frictional connection.

According to a further embodiment, the fitting body comprises a fitting ring. The fitting ring is formed in such a way that the frictional connection between the valve body and the injector body is realized by a slight interference fit between the fitting ring and the wall of the recess of the injector body. The interference fit between the fitting ring and the wall of the recess of the injector body enables the coupling of the valve body to the injector body by the frictional connection in a very easy way.

According to a further embodiment, the valve body and the injector body are fixed together by an overlap weld at the injector body. The overlap weld is characterized by welding the valve body to the injector body in such a way that only the injector body gets directly heated and that the heat is transferred from the injector body to the valve body and that the injector body is heated at an outer shell of the injector body and not at an axial end of the injector body. This contributes to that the valve body stays in its axial position relative to the injector body, when the valve body and the injector body cool down after the welding.

According to a further embodiment, the recess of the injector body comprises the step of the recess of the injector body. The needle body comprises an armature and a needle. The armature is axially arranged between the step of the recess of the injector body and the first axial section of the valve body. The needle protrudes into the recess of the valve body. This contributes to an easy assembling of the needle body.

According to a further embodiment, the injector body comprises an injector housing and a valve body shell. The recess of the injector body comprises a recess of the valve body shell. The first axial section of the valve body is arranged in the recess of the valve body shell. This contributes to the very easy assembling of the injection valve.

According to another embodiment, a method for assembling the injection valve comprises the steps of partly arranging the needle body in the recess of the injector body. Arranging the first axial section of the valve body and the fitting body in the recess of the injector body with the fitting body being arranged between the first axial section of the valve body and the wall of the recess of the injector body. The relative axial position of the valve body to the injector body being representative for an axial movability of the needle body in the recess of the injector body. Welding the injector body to the valve body by heating the injector body from the outside of the injector body in radial direction.

So, the needle body is axially movable as far as the armature of the needle body is axially movable between the step of the recess of the injection valve and the first axial section of the valve body. The further the valve body is introduced into the recess of the injector body, the smaller is the axial movability of the needle body and, in particular, of the armature. The axial movability of the needle body influences the dosing of fluid by the injection valve. So, the axial movability of the needle body may contribute to a calibration of the injection valve. The calibration of the injection valve enables the very precise dosing of the fluid by the injection valve in an easy way.

According to another embodiment, the fitting body is partly arranged in the groove of the first axial section of the valve body. The first axial section of the valve body with the fitting ring is inserted into the recess of the injector body.

Elements with the same design and function that appear in the different illustrations are identified by the same reference characters.

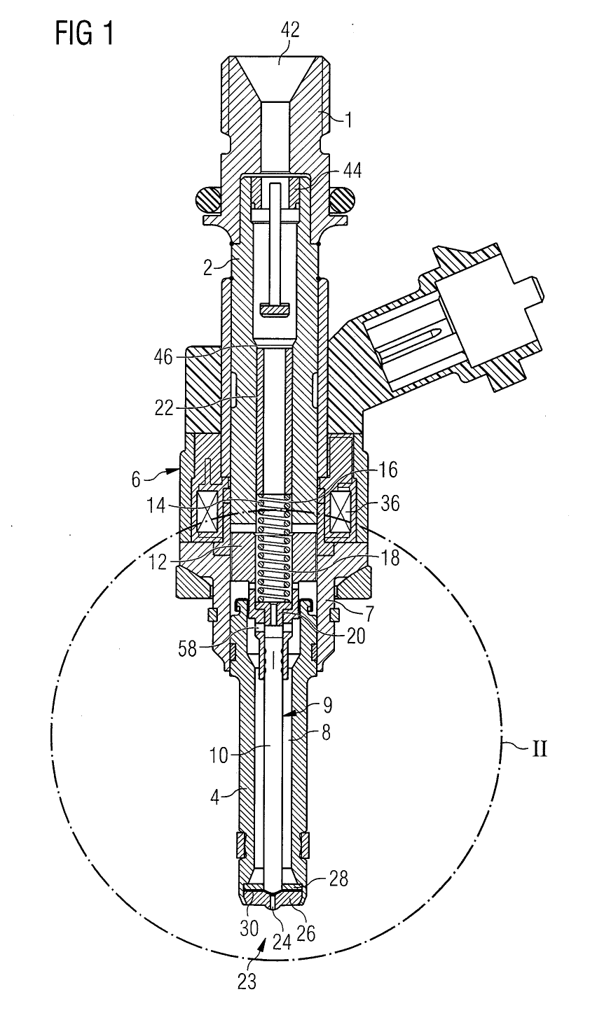

An injection valve (FIG. 1) for dosing fluid is in particular suited for dosing fuel into a combustion chamber of an internal combustion engine. The injection valve comprises an injector body with a recess, a valve group and a fitting adapter 1 for connecting the injection valve to a fluid reservoir, such as a fuel rail. The injector body comprises an inlet tube 2 and a housing 6. The valve group comprises a valve body 4, a valve body shell 7, and a needle body 9 with a needle body recess. A recess 8 in the valve body 4 is provided which takes in part of the needle body 9 movable in axial direction.

The needle body 9 may comprise a needle 10 and an armature 12. If the needle body comprise the needle 10 and the armature 12, the needle body recess comprises a recess 18 of the armature 12. The armature 12 is fixed to the needle 10. The recess 8 of the valve body 4 takes in the needle 10 and preferably a part of the armature 12. Alternatively the needle body may be made of one piece or the needle body may comprise further parts of the needle body.

The recess of the injector body may comprise a recess 16 of the inlet tube 2. The recess 16 of the inlet tube 2 extends to the recess 18 of the armature 12. A spring 14 is arranged in the recess 16 of the inlet tube 2 and/or the recess 18 of the armature 12. Preferably, the spring 14 rests on a spring seat being formed by an anti-bounce disk 20. The spring 14 is in this way mechanically coupled to the needle 10. An adjusting tube 22 is provided in the recess 16 of the inlet tube 2. The adjusting tube 22 forms a further seat for the spring 14 and may during the manufacturing process of the injection valve be axially moved in order to preload the spring 14 in a given way.

In a closed position of the needle 10, it rests sealing up on a seat 26 and prevents in this way a fluid flow through at least one injection nozzle 24. The injection nozzle 24 may, for example, be an injection hole, it may however also be of some other type suitable for dosing fluid. The seat 26 may be made of one part with the valve body 4 or may also be a separate part from the valve body 4. In addition to that, preferably a lower guide 28 for guiding the needle 10 is provided. In addition preferably a swirl disk 30 may be provided.

The injection valve is provided with a drive which preferably is an electromagnetic drive. The electromagnetic drive comprises a coil 36 which is preferably extrusion-coated, the valve body shell 7, the armature 12 and the inlet tube 2. The armature 12 preferably comprises a large diameter compared to the diameter of the needle 10. The larger diameter enables a proper electromagnetic flow through the armature 12 which contributes to a proper controllability of the needle body 9.

If the coil 36 is energized, an electromagnetic force acting on the needle body 4 results. The electromagnetic force acts against the mechanical force obtained from the spring 14. After a given time the coil 36 may be de-energized again. By appropriately energizing the coil 36, the needle body 9, in particular, the needle 10 may in that way be moved away from its closed position which results in a fluid flow from the fluid inlet 42 to the recess 16 of the inlet tube 2 and to the recess 18 of the armature 12, through a fluid path 58 of the armature 12, towards the injection nozzle 24 and through the injection nozzle 24.

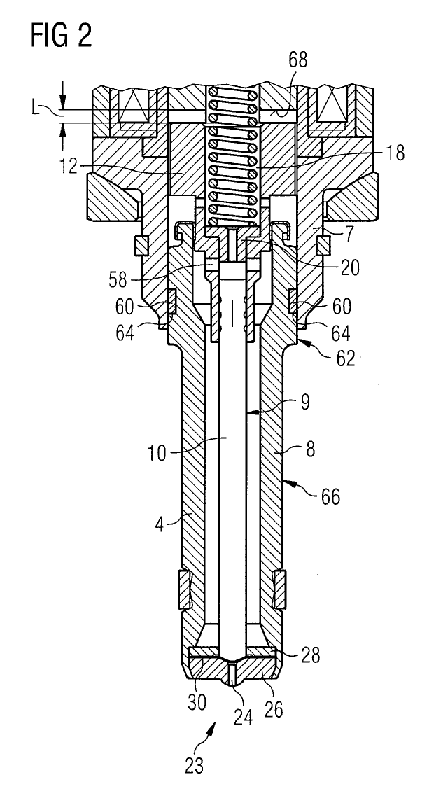

The valve body 4 comprises a first axial section 62 and a second axial section 66 (FIG. 2). The first axial section 62 is formed at an axial end area of the valve body 4. The axial end area of the valve body 4 is arranged facing away from the tip 23 of the valve body 4. The first axial section 62 of the valve body 4 is surrounded by the valve body shell 7. The first axial section 62 of the valve body 4 has a groove 64 of the first axial section 62 of the valve body 4. A fitting body is arranged between the first axial section of the valve body 4 and a wall of the recess 8 of the valve body shell 7. Preferably, the fitting body comprises a fitting ring 60. The fitting ring 60 is arranged in the groove 64 of the first axial section 62 of the valve body 4. Preferably, an outer circumference of the fitting ring 60 is slightly larger than the inner circumference of the recess of the valve body shell 7. In this way, the fitting ring 60 may be fixed into the recess of the valve body shell 7 by an interference fit. Further, the fitting ring 60 is formed and arranged in such a way that the valve body 4 is held in the recess of the valve body shell by a frictional connection which is realized by the interference fit of the fitting ring 60 and the recess of the valve body shell 7. Alternatively, the fitting body comprises a thickness which is bigger than the dephth of the groove 64 and the slight clearance between the first axial section 62 of the valve body 4. Then, the frictional connection is enabled by the fitting body which is pressed between the ground of the groove 64 and the wall of the recess of the valve body shell 7.

Preferably, the fitting ring 60 comprises a material which has a smaller Young's modulus of elasticity than the material of the valve body 4 and/or the injector body 6. For example, the Young's modulus of elasticity is in the range of 2 to 75 GPa. For example, the fitting ring 60 comprises plastic or metal. If the fitting ring 60 comprises plastic, the fitting ring 60 may comprise PTFE without glass or PTFE filled with glass from 15 to 35% or nylon filled with glass up to 20%. If the fitting ring 60 comprises metal, the fitting ring preferably comprises copper, aluminum, bronze or stainless steel. For arranging the fitting ring 60 in the groove 64, the fitting ring 60 may comprise a cut in axial direction. This enables to clamp the fitting ring 60 at the first axial section 62 of the valve body 4. This is especially advantageous, if the fitting ring 60 comprises metal.

Further, the smaller Youngs's modulus of elasticity of the fitting ring 60 enables the provisional fixation of the valve body 4 to the injector body 6 without needing much force to introduce the first axial section 62 of the valve body 4 into the valve body shell 7. If the force on the valve body 4 would be too strong by introducing the first axial section 62, a spring-back effect would force the valve body 4 away from the inlet tube 2, if the force on the valve body 4 decreases. The spring-back effect would lead to a shifting of the axial position of the valve body 4 relative to the valve body shell 7. So, the smaller Youngs's modulus of elasticity of the fitting ring 60 enables a very precise axial positioning of the valve body 4 in the recess of the valve body shell 7.

This is especially advantageous if the axial position of the valve body 4 relative to the injector body 6 is representative for a given calibration of the injection valve. The given calibration may comprise an axial movability of the needle body 9 and, in particular, of the armature 12 between a step 68 of the inlet tube 2 and the first axial section 62 of the valve body 4. The further the valve body 4 is introduced into the recess of the valve body shell 7 the smaller is the axial movability of the needle body 9. The axial movability of the needle body 9 is representative for a fluid flow through the injection nozzle 24 at a given dosing duration.

If the injection valve is assembled, preferably, the spring 14 is arranged in the recess of the injector body 6 and, in particular, in the recess of the inlet tube 2. Then, the needle body 9 is stuck into the recess of the injector body 6 in such a way that the recess of the armature 12 takes in the spring 14. Then, the fitting ring 60 is arranged in the groove 64 of the valve body 4. The valve body 4 with the fitting ring 60 is inserted into the recess of the injector body 6. The clearance fit between the first axial section 62 of the valve body 4 and the wall of the recess of the injector body 6 contributes to an easy insertion of the valve body into the recess of the injector body 6. The frictional connection between the first axial section 62 of the valve body 4, the fitting ring 60, and the wall of the recess of the valve body shell 7 enables to provisionally fixing the valve body 4 to the injector body 6. Then, the valve body 4 cannot fall apart from the injector body 6. This is especially advantageous, if the injection valve is assembled automatically.

The invention is not restricted by the explained embodiments. For example, the injection valve may be of an outward opening type. Further, the actor may comprise a piezoelectric element or a hydraulic valve.

What is claimed is:

1. An injection valve for dosing fluid comprising
an injector body having a first recess,
a valve body having a second recess and having an injection nozzle at a tip of the valve body,
a first axial section of the valve body which is formed at an axial end area of the valve body facing away from the tip of the valve body and which is arranged in the first recess comprising a slight clearance fit to a wall of the first recess,
a needle body which is partly and axially movable arranged in the first recess and which protrudes into the second recess in such a way that it prevents a fluid flow through the injection nozzle in a closed position and that it enables the fluid flow through the injection nozzle outside of the closed position,
a fitting body which is formed and arranged between the first axial section of the valve body and the wall of the first recess in such a way that the valve body and the fitting body are fixed to the injector body by a frictional connection.

2. The injection valve according to claim 1, wherein the first axial section of the valve body comprises a circumferential groove which partly takes in the fitting body.

3. The injection valve according to claim 1, wherein the fitting body comprising a material which has a smaller Young's modulus of elasticity than the material of the valve body and/or of the injector body.

4. The injection valve according to claim 1, wherein the fitting body comprises a fitting ring which is formed in such a way that the frictional connection between the valve body and the injector body is realized by a slight interference fit between the fitting ring and the wall of the first recess.

5. The injection valve according to claim 1, wherein the valve body and the injector body being fixed together by an overlap weld at the injector body.

6. The injection valve according to claim 1, wherein
the recess of the injector body comprises a step of the first recess,
the needle body comprises an armature and a needle,
the armature being axially arranged between the step of the first recess and the first axial section of the valve body,
the needle protruding into the second recess.

7. The injection valve according to claim 1, wherein the injector body comprises an injector housing and a valve body shell and wherein the first recess comprises a third recess of the valve body shell and wherein the first axial section of the valve body being arranged in the third recess.

8. A method for assembling an injection valve, comprising the steps of:
partly arranging a needle body in a first recess formed in an injector body,
arranging a first axial section of a valve body and a fitting body in the first recess with the fitting body being arranged between the first axial section of the valve body and a wall of the first recess and wherein the relative axial position of the valve body to the injector body is representative for an axial movability of the needle body in the first recess,
welding the injector body to the valve body by heating the injector body from the outside of the injector body in radial direction.

9. The method according to claim 8, further comprising the steps of partly arranging a fitting ring in a groove of the first axial section of the valve body and inserting the first axial section of the valve body with the fitting ring into the first recess.

10. An injection valve for dosing fluid comprising
an injector body having a first recess,
a valve body having a second recess and having an injection nozzle at a tip of the valve body,
a first axial section of the valve body which is formed at an axial end area of the valve body facing away from the tip of the valve body and which is arranged in the first recess comprising a slight clearance fit to a wall of the first recess,
a needle body which is partly and axially movable arranged in the first recess and which protrudes into the second recess in such a way that it prevents a fluid flow through the injection nozzle in a closed position and that it enables the fluid flow through the injection nozzle outside of the closed position, and
a fitting body which is formed and arranged between the first axial section of the valve body and the wall of the first recess in such a way that the valve body and the fitting body are fixed to the injector body by a frictional connection, wherein
the first axial section of the valve body comprises a circumferential groove which partly takes in the fitting body.

11. The injection valve according to claim 10, wherein the fitting body comprising a material which has a smaller Young's modulus of elasticity than the material of the valve body and/or of the injector body.

12. The injection valve according to claim 10, wherein the fitting body comprises a fitting ring which is formed in such a way that the frictional connection between the valve body and the injector body is realized by a slight interference fit between the fitting ring and the wall of the first recess.

13. The injection valve according to claim 10, wherein the valve body and the injector body being fixed together by an overlap weld at the injector body.

14. The injection valve according to claim 10, wherein
the recess of the injector body comprises a step of the first recess,
the needle body comprises an armature and a needle,
the armature being axially arranged between the step of the first recess and the first axial section of the valve body,
the needle protruding into the second recess.

15. The injection valve according to claim 10, wherein the injector body comprises an injector housing and a valve body shell and wherein the first recess comprises a third recess of the valve body shell and wherein the first axial section of the valve body being arranged in the third recess.
